(19) United States
(12) Patent Application Publication
(10) Pub. No.: US 2025/0193869 A1
(43) Pub. Date: Jun. 12, 2025

(54) Method for enabling wireless communication device to access services provided by Radio Access Network and related devices

(71) Applicant: PURPLEVINE INNOVATION COMPANY LIMITED, Hongkong (HK)

(72) Inventor: Yi-Ting LIN, Hongkong (HK)

(73) Assignee: PURPLEVINE INNOVATION COMPANY LIMITED, Hongkong (HK)

(21) Appl. No.: 19/025,099

(22) Filed: Jan. 16, 2025

Related U.S. Application Data
(63) Continuation of application No. PCT/CN2023/111309, filed on Aug. 4, 2023.
(60) Provisional application No. 63/370,599, filed on Aug. 5, 2022.

(51) Int. Cl. H04W 72/11; H04W 72/1268; H04W 76/20

(52) U.S. Cl. CPC H04W 72/11; H04W 72/1268; H04W 76/20

(57) ABSTRACT

A method for enabling a wireless communication device to access services provided by a Radio Access Network, wherein an Extended Reality (XR) configuration is configured, and a non-integer periodicity is configured in the XR configuration for XR traffic, and wherein the XR configuration is a semi-persistent scheduling (SPS) configuration that is a periodic resource allocation scheme for downlink (DL).

### CROSS REFERENCE TO RELATED APPLICATIONS

This application is a bypass continuation application of International Application No. PCT/CN2023/111309, filed on Aug. 4, 2023, and entitled “METHOD FOR ENABLING WIRELESS COMMUNICATION DEVICE TO ACCESS SERVICES PROVIDED BY RADIO ACCESS NETWORK AND RELATED DEVICES”. The international application claims priority to U.S. Provisional Application No. 63/370,599, filed on Aug. 5, 2022, and entitled “Capacity enhancements for extended reality (XR) services”. Related International Patent Application No. PCT/CN2023/093657, filed on May 11, 2023, claims the benefit of priority to U.S. Provisional Application No. 63/340,509 and U.S. Provisional Application No. 63/381,371. Related International Patent Application No. PCT/CN2023/093666, filed on May 11, 2023, claims the benefit of priority to U.S. Provisional Application No. 63/340,509 and U.S. Provisional Application No. 63/381,371. The entire disclosures of the above application are incorporated herein by reference.

### TECHNICAL FIELD

The present application relates to wireless communication, and more particularly, to a method for enabling a wireless communication device to access services provided by a Radio Access Network, and related devices such as a user equipment (UE) and a base station (BS).

### BACKGROUND ART

This background section introduces aspects that may facilitate a better understanding of the disclosure. Accordingly, the statements of this section are to be read in this light and are not to be understood as admissions about what is in the prior art or what is not in the prior art.

Communication systems and networks have developed towards being a broadband and mobile system. In cellular wireless communication systems developed by the Third Generation Partnership Project (3GPP), user equipment (UE) is connected by a wireless link to a radio access network (RAN). The RAN includes a set of base stations (BSs) which provide wireless links to the UEs located in cells covered by the base station, and an interface to a core network (CN) which provides overall network control. As will be appreciated, the RAN and CN each conduct respective functions in relation to the overall network. The 3GPP has developed the so-called Long Term Evolution (LTE) system, namely, an Evolved Universal Mobile Telecommunication System Territorial Radio Access Network (E-UTRAN), for a mobile access network where one or more macro-cells are supported by a base station known as an eNodeB or eNB (evolved NodeB). More recently, evolved from LTE, the so-called 5G or New Radio (NR) systems where one or more cells are supported by a base station known as a gNB.

The 5G NR standard supports a multitude of different services each with very different requirements. These services include Enhanced Mobile Broadband (eMBB) for high data rate transmission, Ultra-Reliable Low Latency Communication (URLLC) for devices requiring low latency and high link reliability and Massive Machine-Type Communication (mMTC) to support a large number of low-power devices for a long life-time requiring highly energy efficient communication.

During 3GPP Rel-17, traffic pattern for EXtended Reality (XR) and Cloud Gaming (CG) was studied. The characteristics of XR/CG traffic include small traffic periodicity with jitter, large packet size, and different traffic patterns between uplink (UL) and downlink (DL). The existing power saving mechanisms for Enhanced Mobile Broadband (eMBB) and Ultra-Reliable and Low Latency Communications (URLLC) may not be directly applied to XR/CG service. A 3GPP Rel-18 Work Item (WI) on Study on XR Enhancements for NR (FS_NR_XR_enh) was approved to study how to enhance the standard specifications for XR/CG services. According to the objectives of the WID for Rel-18 IoT NTN, how to enhance the existing power saving mechanisms, e.g., connected mode discontinuous reception (CDRX), Physical Downlink Control Channel (PDCCH) monitoring for the UEs using XR services is an important issue to be resolved.

EXtended Reality (XR) and Cloud Gaming (CG) are important services for New Radio (NR) in Rel-18 and beyond. Cloud Gaming (CG) is a type of online gaming that runs video games where most computations related to gaming are offloaded from the UE to remote server(s). Extended reality (XR) is a term referring to all real-and-virtual combined environments combined with human-to-human and human-to-machine communications through handheld and wearable UEs. The XR use cases may include augmented reality (AR), virtual reality (VR), and mixed reality (MR). While XR and CG offer an attractive set of use cases for future mobile systems, they also present NR with a set of challenges that need to be studied and potentially addressed.

Many XR and CG use cases are presented by video streaming which is characterized by quasi-periodic traffic with possible jitter and high data rate in downlink (DL) combined with the frequent uplink (UL) (i.e., pose/control update) and/or UL video streaming. DL and UL traffic are also characterized by a relatively tight packet delay budget (PDB). Therefore, it is necessary to study and specify possible solutions to better support these challenging services.

The typical XR DL/UL frame rates are 60, 90, or 120 frames per seconds (fps) with frame periodicities of 50/3 ms, 100/9 ms, and 25/3 ms, respectively. At each transmission time, a traffic burst with different types of video frames (e.g., I-frame, P-frame, or B-frame) may be received/transmitted by the UE. The video frame may consist of variable payload size and the number of protocol data units (PDU) per video frame (PDUs/frame) may vary depending on the type of generated video frame. Because traffic bursts are periodic, the XR traffic bursts are suitable for transmission on periodic radio resources. The periodic resource could be scheduled by legacy connected mode discontinuous reception (CDRX) and/or downlink semi-persistent scheduling (SPS)/uplink configured grant (CG). However, CDRX cycle values support only integer multiples of 1 ms. (i.e., The long cycle values of Rel-15/16 CDRX are 10, 20, 32, 40, 60 ms, etc. and short cycle values are 2, 3, 4, 5, 6, 7, 8, 10, 14, 16, 20, 30, 32, 35, 40 ms, etc.) Whichever cycle periodicity is chosen from the available values, it cannot be perfectly aligned with DL frame arrival timing. FIG. 1 illustrates the case of mismatch between 60 fps and CDRX cycles. For the case of 16 ms CDRX cycle, the traffic will gradually arrive behind the CDRX ON period. For the case of 17 ms CDRX cycle, instead, the traffic will gradually arrive earlier than the CDRX ON period. This mismatch would lead to XR capacity loss due to larger latency and/or larger UE power consumption to keep the same latency performance.

SPS/CG resource allocation schemes also have the same problem. Current SPS periodicity values support only integer multiples of 1 ms, and CG periodicity values support 2, 7 symbols, and 1, 2, 4, 5, 8, 10, 16, 20, 32, 40, 64, 80, 128, 160, 320, 640 ms, etc. In addition, a fixed transport block size (TBS) is configured for each SPS/CG grant. Therefore, current SPS/CG may not be suitable for (i) the non-integer XR traffic periodicity, (ii) variable XR data rate, and (iii) quasi-periodic XR periodicity with jitter, and SPS/CG should be enhanced to better support XR and CG services.

The technical problems can be briefly summarized as how to enhance the current CDRX and/or SPS/CG configuration to adapt the XR/CG traffic, and how the eNB/UE can precisely configure and/or adjust the CDRX and/or SPS/CG configuration(s) based on the XR/CG traffic characteristics, in which the traffic characteristics may include multiple streams with non-integer periodicities and arrival time jitter.

Therefore, there is an urgent need to develop a new approach to solve above problems.

### RELATED ARTS

### Discontinuous Reception (DRX):

DRX is a method used in cellular communication to conserve the battery power of the UE. DRX in LTE/NR is introduced to improve UE power consumption by allowing the UE to periodically enter off state to stop monitoring Physical Downlink Control Channel (PDCCH). During the off state, the UE turns off its receiver such that UE power consumption is reduced. The UE wakes up periodically during on state to monitor PDCCH for downlink (DL) data reception. The interval of the ON state (i.e., or called ON period) is configured by the RRC parameter, drx-onDurationTimer. An ON period and an OFF period makes up a DRX cycle which is illustrated in FIG. 2.

The triggering condition for a DRX cycle is as follows:

When short DRX is configured as illustrated in FIG. 3 and data transmission/reception occurs in the previous ON period, the next ON period starts at a subframe satisfying [(SFN×10)+subframe number]mod (drx-ShortCycle)=(drx-StartOffset) mod (drx-ShortCycle), where SFN stands for system frame number (SFN). The actual ON period starts after a certain slot offset which is configured by the RRC parameter, drx-slotoffset. The value of drx-slotoffset ranges of 0-31 and is in units of 1/32 ms. drx-ShortCycle defines the short DRX cycle configured for the UE and its value ranges of 2-640 ms. Drx-startoffset indicates the start subframe of the short DRX cycle and its value is in units of 1 ms.

When the drx-ShortCycleTimer (i.e., number of short DRX cycles and the number ranges from 1 to 16) is expired or a short DRX cycle is not configured, the UE uses a long DRX cycle. The ON period of the long DRX cycle at a subframe satisfying [(SFN×10)+subframe number]mod (drx-LongCycle)=(drx-StartOffset), where drx-LongCycle defines the long DRX cycle configured for the UE, and its value ranges from 10 to 10240 ms. Long DRX cycle configuration is the default for DRX, and a short DRX cycle configuration is optional. When a short DRX cycle is configured, a long DRX cycle duration is an integer multiple of the short DRX cycle duration.

Semi-persistent scheduling (SPS) and configured grant (CG):

Semi-persistent scheduling (SPS) is a periodic resource scheduling for downlink transmission and configured grant (CG) is a periodic resource scheduling for uplink transmission. By SPS/CG, the gNB can schedule multiple resources at a time without transmitting downlink control information (DCI) for each SPS/CG grant. SPS/CG can be configured or re-configured by SPS-Config/ConfiguredGrantConfig information element (IE) in RRCReconfiguration message. In the SPS-Config/ConfiguredGrantConfig IE, parameters such as periodicity, number of Hybrid Automatic Repeat reQuest (HARQ) processes, Modulation and Coding Scheme (MCS) table, etc. are configured by the gNB. To determine the position of the scheduled SPS resource, the gNB and the UE follow the triggering equation for the N^{th} DL assignment:

(numberOfSlotsPerFrame×SFN+slot number in the frame)=[(numberOfSlotsPerFrame×SFNstarttime+slotstarttime)+N×periodicity×numberOfSlotsPerFrame/10]modulo (1024×numberOfSlotsPerFrame), where numberOfSlotsPerFrame refers to the number of consecutive slots per frame; and the periodicity is the periodicity of the SPS radio resources.

The gNB and the UE keep synchronized at the eligible slots (i.e., slotstarttime) of the frames (i.e., SFN_{start time}) to transmit/receive the DL SPS grants.

There are two types for configured grant (CG) resource scheduling. For the CG Type 1, the gNB configures and activates the CG configuration by RRC message (i.e., RRCReconfiguration message). The gNB and the UE follow the triggering equation for the N^{th} UL assignment:

### UL CG Type 1:

[(SFN×numberOfSlotsPerFrame×numberOfSymbolsPerSlot)+(slot number in the frame×numberOfSymbolsPerSlot)+symbol number in the slot]=(timeReferenceSFN×numberOfSlotsPerFrame×numberOfSymbolsPerSlot+timeDomainOffset×numberOfSymbolsPerSlot+S+N×periodicity) modulo (1024×numberOfSlotsPerFrame×numberOfSymbolsPerSlot).

For the CG resource Type 2, the gNB configures the CG configuration by RRC message and then activates the CG configuration by downlink control information (DCI). The gNB and the UE follow the triggering equation for the N^{th} UL assignment:

### UL CG Type 2:

[(SFN×numberOfSlotsPerFrame×numberOfSymbolsPerSlot)+(slot number in the frame×numberOfSymbolsPerSlot)+symbol number in the slot]=[(SFN_{start time}×numberOfSlotsPerFrame×numberOfSymbolsPerSlot+slot_{start time}×numberOfSymbolsPerSlot+symbol_{start time})+N×periodicity]modulo (1024×numberOfSlotsPerFrame×numberOfSymbolsPerSlot), where numberOfSymbolsPerSlot refers to the number of consecutive symbols per slot; numberOfSlotsPerFrame refers to the number of consecutive slots per frame; and the periodicity is the periodicity of the CG radio resources.

The gNB and the UE keep synchronized at the eligible symbols (i.e., symbol_{start time}) of the slots (i.e., slot_{start time}) of the frame (i.e., SFN_{start time}) to receive/transmit the UL CG grants.

### SUMMARY

In a first aspect, an embodiment of the present application provides a method for enabling a wireless communication device to access services provided by a Radio Access Network, wherein an Extended Reality (XR)/Cloud Gaming (CG) configuration is configured, and non-integer periodicity is configured in the XR/CG configuration for XR/CG traffic.

In a second aspect, an embodiment of the present application provides a method for enabling a wireless communication device to access services provided by a Radio Access Network, wherein an Extended Reality (XR)/Cloud Gaming (CG) configuration is configured, and an XR/CG cycle is configured in the XR/CG configuration, and wherein the XR/CG cycle is modified based on burst arrival interval to eliminate a mismatch between the burst arrival interval and the XR/CG cycle.

In a third aspect, an embodiment of the present application provides a method for enabling a wireless communication device to access services provided by a Radio Access Network, wherein a specific cycle is configured with an ON period for transmission of at least one of control information or data and an OFF period during which the transmission is suspended, and wherein the ON period of the specific cycle is extended to cover an arrival interval of at least one data burst plus a data arrival jitter.

In a fourth aspect, an embodiment of the present application provides a method for enabling a wireless communication device to access services provided by a Radio Access Network, wherein physical downlink control channel (PDCCH) monitoring periodicity is dynamically changed based on a search space set group (SSSG) switch indication, and wherein at least two search spaces are configured, one of the at least two search spaces is for sparse PDCCH monitoring and the other one of the at least two search spaces is for dense PDCCH monitoring.

In a fifth aspect, an embodiment of the present application provides a method for enabling a wireless communication device to access services provided by a Radio Access Network, wherein multiple discontinuous reception (DRX) configurations with different start offsets and different DRX cycles are configured, and wherein one of the multiple DRX configurations is activated at a time.

In a sixth aspect, an embodiment of the present application provides a method for enabling a wireless communication device to access multi-modality services provided by a Radio Access Network, wherein an Extended Reality (XR)/Cloud Gaming (CG) configuration is configured for the multi-modality services, and an XR/CG cycle is configured in the XR/CG configuration, and wherein multiple periodic resources are scheduled in an ON period of the XR/CG cycle configured in the XR/CG configuration.

In a seventh aspect, an embodiment of the present application provides a user equipment (UE), including: a memory, configured to store program instructions; a transceiver, configured to transmit and receive data; and a processor, coupled to the memory and the transmitter, configured to call and run the program instructions stored in a memory, to cooperate with the memory to execute the method of any of afore-described aspects.

In an eighth aspect, an embodiment of the present application provides abase station (BS), including: a memory, configured to store program instructions; a transceiver, configured to transmit and receive data; and a processor, coupled to the memory and the transmitter, configured to call and run the program instructions stored in a memory, to cooperate with the memory to execute the method of any of afore-described aspects.

In a ninth aspect, an embodiment of the present application provides a non-transitory computer readable storage medium, configured to store a computer program, which enables a computer to execute the method of any of afore-described aspects.

In a tenth aspect, an embodiment of the present application provides a computer readable storage medium provided for storing a computer program, which enables a computer to execute the method of any of afore-described aspects.

In an eleventh aspect, an embodiment of the present application provides a computer program product, which includes computer program instructions enabling a computer to execute the method of any of afore-described aspects.

In a twelfth aspect, an embodiment of the present application provides a computer program, when running on a computer, enabling the computer to execute the method of any of afore-described aspects.

### DESCRIPTION OF DRAWINGS

In order to more clearly illustrate the embodiments of the present application or related art, the following figures that will be described in the embodiments are briefly introduced. It is obvious that the drawings are merely some embodiments of the present application, a person having ordinary skill in this field can obtain other figures according to these figures without paying the premise.

FIG. 1 is a schematic diagram illustrating a mismatch between XR DL traffic (60 fps) and legacy CDRX periodicity (16 and 17 ms).

FIG. 2 is a schematic diagram illustrating a long DRX configuration.

FIG. 3 is a schematic diagram illustrating a short DRX configuration.

FIG. 4 is a block diagram illustrating one or more UEs, a base station and a network entity device in a communication network system according to an embodiment of the present application.

FIG. 5 is a schematic diagram illustrating radio protocol architecture within gNB and UE.

FIG. 6 is a schematic diagram illustrating a gNB further including a centralized unit (CU) and a plurality of distributed unit (DUs).

FIG. 7 is a schematic diagram illustrating XR/CG cycle modified based on the burst arrival interval.

FIG. 8 is a schematic diagram illustrating the first subframe number of the ON period when the XR/CG cycle=16 ms.

FIG. 9 is a schematic diagram illustrating the first subframe number of the ON period when the XR/CG cycle=16 ms with T=2 ms.

FIG. 10 is a schematic diagram illustrating an XR/CG configuration with {16 ms, 17 ms, 17 ms} periodicities composed by three XR/CG configurations with {0 ms, 16 ms, 33 ms} start offsets.

FIG. 11 is a schematic diagram illustrating ON period adjusted to accommodate the jitter.

FIG. 12 is a schematic diagram illustrating short cycles configured within another long cycle.

FIG. 13 is a schematic diagram illustrating PDCCH-based power saving combined with DRX-based power saving.

FIG. 14 is a schematic diagram illustrating grouped SPS and CG configurations for a multi-modality service.

FIG. 15 is a schematic diagram illustrating multiple XR/CG configurations for a multi-modality service.

FIG. 16 is a schematic diagram illustrating XR/CG resource allocation for a UE.

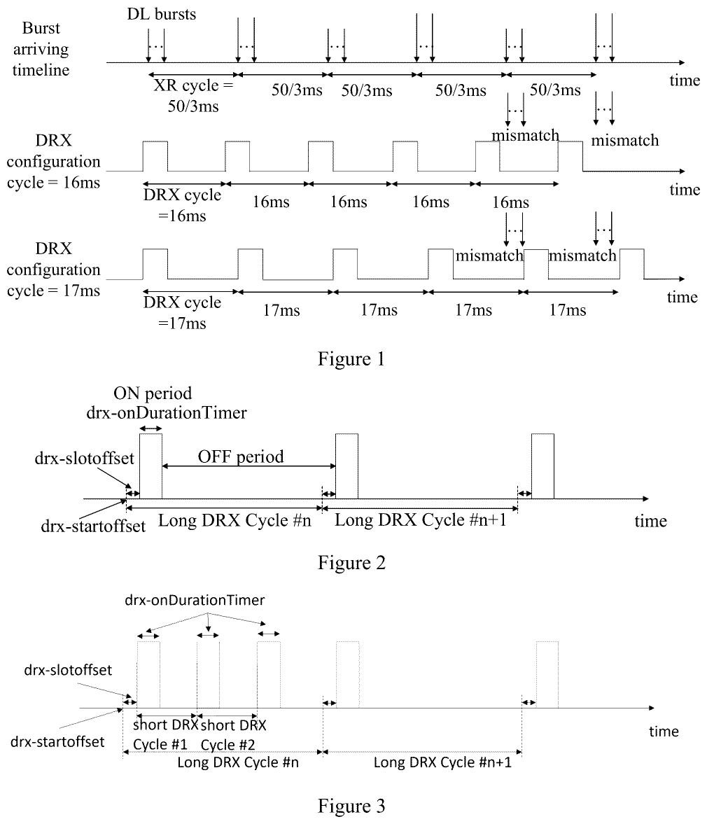

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present application are merely for describing the purpose of the certain embodiment, but not to limit the disclosure.

In this document, the symbol “/” should be interpreted to indicate “and/or.” A combination such as “at least one of A, B, or C,” “one or more of A, B, or C,” “at least one of A, B, and C,” “one or more of A, B, and C,” or “A, B, and/or C” may be A only, B only, C only, A and B, A and C, B and C, or A and B and C, where any combination may contain one or more members of A, B, or C.

This invention realizes XR/CG enhancements in many aspects as follows.

Configure a Specific XR/CG Cycle with Non-Integer Periodicity.

A non-integer XR/CG cycle is configured for XR/CG service. The non-integer value needs to be specified in the standard specification.

### Modified the XR/CG Cycle Based on the Triggering Equation.

Fine-tune the XR/CG cycle within a fixed longer cycle. The triggering equation needs to be specified in the standard specification.

### Modified the XR/CG Cycle by Configuring Multiple XR/CG Configurations.

Multiple XR/CG configurations for an XR/CG service are to be specified in the standard specification.

### Handling Jitter of Traffic Arrival Time.

Large ON period of an XR/CG cycle is configured to cover the traffic burst arrival. During the ON period, DRX cycles, SPS/CG configurations, and/or different search spaces may be configured to reduce the PDCCH monitoring.

### Supporting Multi-Modality Service for XR/CG.

A group of SPS/CG configurations for an XR/CG service are to be specified in the standard specification.

Based on the proposed XR/CG configuration and SPS/CG enhancements, the UE could support XR/CG services with non-integer traffic periodicities, variable data rate, and quasi-periodic periodicity with jitter.

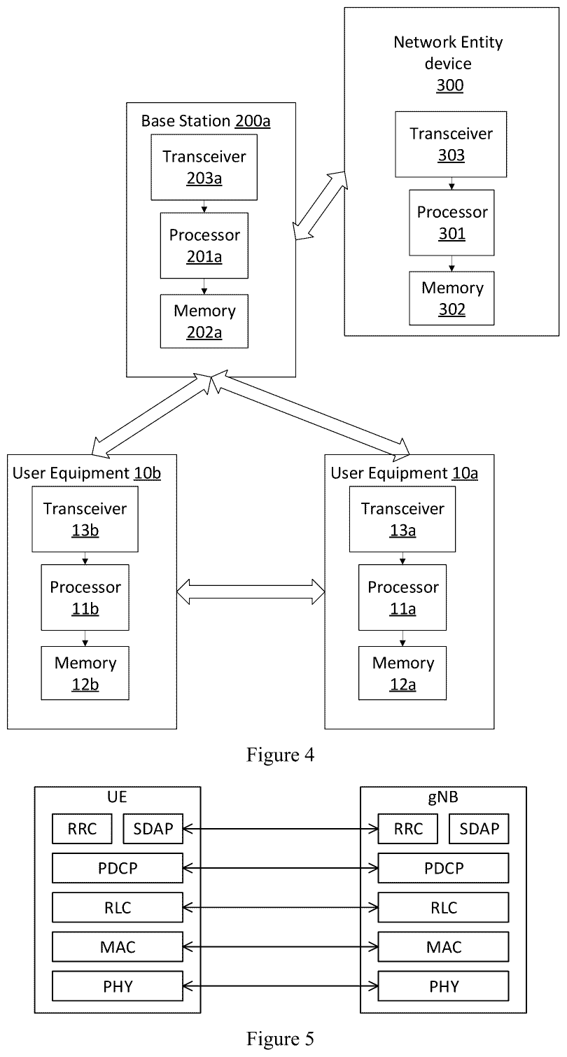

FIG. 4 illustrates that, in some embodiments, one or more user equipments (UEs) 10a, 10b, a base station (e.g., gNB or eNB) 200a and a network entity device 300 for wireless communication in a communication network system according to an embodiment of the present application are provided. With reference to FIG. 4, a UE 10a, a UE 10b, a base station 200a, and a network entity device 300 executes embodiments of the method according to the present application. Connections between devices and device components are shown as lines and arrows in the FIG. 4. The UE 10a may include a processor 11a, a memory 12a, and a transceiver 13a. The UE 10b may include a processor 11b, a memory 12b, and a transceiver 13b. The base station 200a may include a processor 201a, a memory 202a, and a transceiver 203a. The network entity device 300 may include a processor 301, a memory 302, and a transceiver 303. Each of the processors 11a, 11b, 201a, and 301 may be configured to implement proposed functions, procedures and/or methods described in this description. Layers of radio interface protocols may be implemented in the processors 11a, 11b, 201a, and 301. Each of the memory 12a, 12b, 202a, and 302 operatively stores a variety of program and information to operate a connected processor. Each of the transceiver 13a, 13b, 203a, and 303 is operatively coupled with a connected processor, transmits and/or receives radio signals. The base station 200a may be an eNB, a gNB, or one of other radio nodes.

Each of the processor 11ₐ, 11b, 201a, and 301 may include a general-purpose central processing unit (CPU), an application-specific integrated circuits (ASICs), other chipsets, logic circuits and/or data processing devices. Each of the memory 12a, 12b, 202a, and 302 may include a read-only memory (ROM), a random access memory (RAM), a flash memory, a memory card, a storage medium, other storage devices, and/or any combination of the memory and storage devices. Each of the transceiver 13a, 13b, 203a, and 303 may include baseband circuitry and radio frequency (RF) circuitry to process radio frequency signals. When the embodiments are implemented in software, the techniques described herein can be implemented with modules, procedures, functions, entities and so on, that perform the functions described herein. The modules can be stored in a memory and executed by the processors. The memory can be implemented within a processor or external to the processor, in which those can be communicatively coupled to the processor via various means are known in the art.

The network entity device 300 may be a node in a central network (CN). The CN may include LTE CN or 5G core (5GC) which may include user plane function (UPF), session management function (SMF), access and mobility management function (AMF), unified data management (UDM), policy control function (PCF), control plane (CP)/user plane (UP) separation (CUPS), authentication server function (AUSF), network slice selection function (NSSF), the network exposure function (NEF), and other network entities.

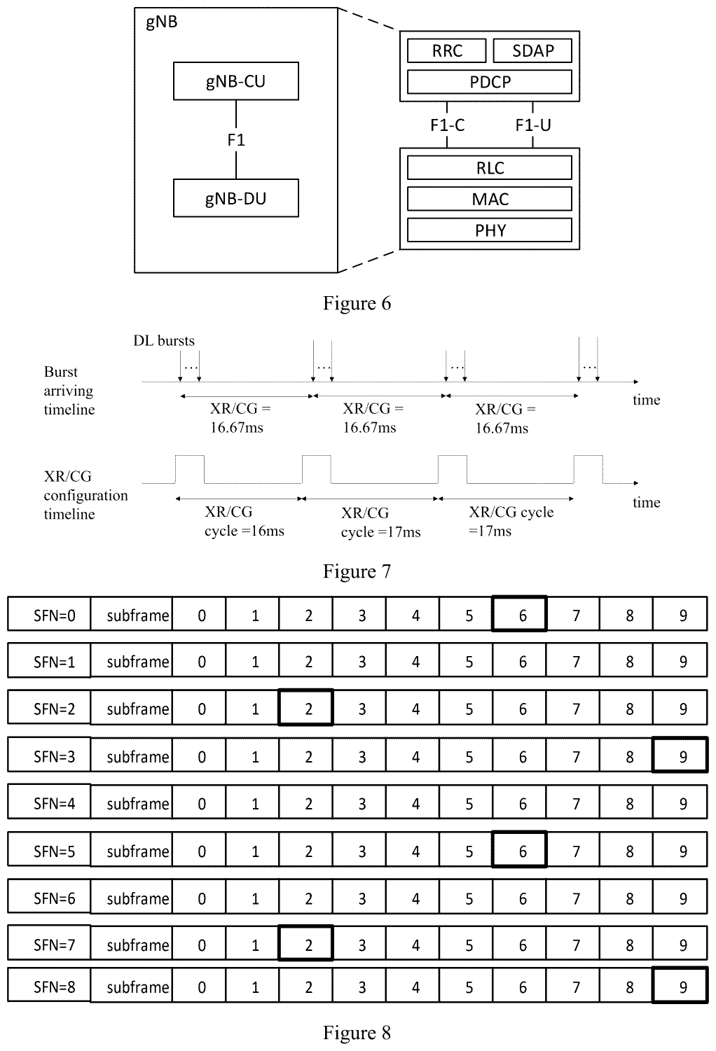

The radio protocol architecture within the base station (gNB) and UE is shown in FIG. 5, which includes Radio Resource Control (RRC), Service Data Adaptation Protocol (SDAP), Packet Data Convergence Protocol (PDCP), Radio Link Control (RLC), Medium Access Control (MAC), and Physical Layer Protocol (PHY). In RAN functional split, the gNB further includes a centralized unit (CU) and a plurality of distributed unit (DUs) as shown in FIG. 6. The protocol stack of CU includes an RRC layer, an optional SDAP layer, and a PDCP layer, while the protocol stack of DU includes an RLC layer, a MAC layer, and a PHY layer. The F1 interface between the CU and DU is established between the PDCP layer of the protocol stack and the RLC layer of the protocol stack.

1. Configure a Specific XR/CG Cycle with Non-Integer Periodicity.

To enable a wireless communication device to access services (such as Extended Reality (XR)/Cloud Gaming (CG) service) provided by a Radio Access Network, an XR/CG configuration is configured, and non-integer periodicity is configured in the XR/CG configuration for XR/CG traffic. The non-integer periodicity may comprise at least one of 100/3, 50/3, 100/9 or 25/3 in a unit of microsecond. In an embodiment, the XR/CG configuration may be a discontinuous reception (DRX) configuration or comprises the DRX configuration, which configures a DRX cycle with a DRX ON period for transmission of at least one of control information or data and a DRX OFF period during which the transmission is suspended, and wherein the DRX cycle has the non-integer periodicity. The DRX cycle having the non-integer periodicity may be a short DRX cycle. The DRX cycle having the non-integer periodicity may be a long DRX cycle. In another embodiment, the XR/CG configuration is a semi-persistent scheduling (SPS) configuration or comprises the SPS configuration, which configures the non-integer periodicity for SPS resources, and wherein SPS is a periodic resource allocation scheme for downlink (DL). In still another embodiment, the XR/CG configuration is a configured grant configuration or comprises the configured grant configuration, which configures the non-integer periodicity for configured grant resources, and wherein configured grant is a periodic resource allocation scheme for uplink (UL). Further details are provided below.

For the XR/CG traffic characteristic of non-integer periodicity, the legacy DRX scheme may be reused for XR/CG configuration. Table 1 below shows possible configurations for long DRX cycles and shortDRX cycles in current 3GPPTechnical Specification (TS) 38.331. In current specification, only integer-valued periodicities could be configured for DRX cycles. To provide non-integer periodicities for XR/CG configuration, the most straightforward way is to add non-integer values, such as 100/3 ins, 100/6 ins, 100/9 ins, and 100/12 ms for XR/CG cycles with 30, 60, 90, and 120 fps, respectively.

TABLE 1
Long and short DRX cycle in TS 38.331 (prior art).

| | |
|---|---|
| drx-LongCycleStartOffset | CHOICE { |
| ms10 | INTEGER(0..9), |
| ms20 | INTEGER(0..19), |
| ms32 | INTEGER(0..31), |
| ms40 | INTEGER(0..39), |
| ms60 | INTEGER(0..59), |
| ms64 | INTEGER(0..63), |
| ms70 | INTEGER(0..69), |
| ms80 | INTEGER(0..79), |
| ms128 | INTEGER(0..127), |
| ms160 | INTEGER(0..159), |
| ms256 | INTEGER(0..255), |
| ms320 | INTEGER(0..319), |
| ms512 | INTEGER(0..511), |
| ms640 | INTEGER(0..639), |
| ms1024 | INTEGER(0..1023), |
| ms1280 | INTEGER(0..1279), |
| ms2048 | INTEGER(0..2047), |
| ms2560 | INTEGER(0..2559), |
| ms5120 | INTEGER(0..5119), |
| ms10240 | INTEGER(0..10239) |

},

| | |
|---|---|
| shortDRX | SEQUENCE { |
| drx-ShortCycle | ENUMERATED { |
| | ms2, ms3, ms4, ms5, ms6, ms7, ms8, ms10, ms14, ms16, ms20, |

ms30, ms32,ms35, ms40, ms64, ms80, ms128, ms160, ms256, ms320, ms512, ms640, spare9,
spare8, spare7, spare6, spare5, spare4, spare3, spare2, spare1 },

However, it is very difficult and not efficient to enumerate all non-integer values. One of the solutions is to add a configuration for each of the traffic arrival patterns. (i.e., 30, 60, 90, 120 fps), which are 100/3 ms, 50/3 ms, 100/9 ms, and 25/3 ms for 30, 60, 90, and 120 fps respectively, could be configured as extensions for Rel-18 drx-ShortCycle or for a new XR/CG configuration. Although the extensions are configured for short DRX cycles as listed in Table 2 below, the same extensions may be configured for long DRX cycles.

TABLE 2
Extension for Rel-18 Short DRX cycle information element.

| | |
|---|---|
| shortDRX | SEQUENCE { |
| drx-ShortCycle-r18 | ENUMERATED { |
| | ms100/3, ms50/3, ms100/9, ms25/3, spare4, spare3, spare2, spare1 |
| }, | |

The corresponding Long DRX cycle should be added because the long DRX cycle duration is an integer multiple of a short DRX cycle duration. Some examples of the long DRX cycles are listed in Table 3 below.

TABLE 3
Extension for Long DRX cycle with start offset

| | |
|---|---|
| drx-LongCycleStartOffset-r18 | CHOICE { |
| ms100 | INTEGER(0..99), |
| ms200 | INTEGER(0..199), |
| ms400 | INTEGER(0..399), |
| ms800 | INTEGER(0..799), |
| ms1000 | INTEGER(0..999), |
| ms2000 | INTEGER(0..1999), |
| ms4000 | INTEGER(0..3999), |
| ms8000 | INTEGER(0..7999), |
| ms10000 | INTEGER(0..9999), |
| }, | |

For a new XR/CG configuration, only one XR/CG cycle (i.e., no need to configure short XR/CG cycle(s) and long XR/CG cycle(s) separately) may be configured. The same values of non-integer periodicities (e.g., 100/3 ins, 50/3 ins, 100/9 ins, 25/3 ins) and associated start offsets are shown in the following Table 4. Most parameters of the legacy DRX configuration could be reused for an XR/CG configuration. Configuring a new XR/CG configuration will have less impact on legacy DRX configuration. In addition, legacy DRX and/or SPS/CG configuration(s) could be configured under the XR/CG configuration.

TABLE 4
A new configuration for XR/CG cycle with start offset.

| | |
|---|---|
| XRCG-CycleStartOffset-r18 | CHOICE { |
| ms100/3 | INTEGER(0..33), |
| ms50/3 | INTEGER(0..16), |
| ms100/9 | INTEGER(0..11), |
| ms25/3 | INTEGER(0..8), |
| }, | |

1.1 Configure an SPS/CG Configuration with Non-Integer Periodicity.

Semi-persistent scheduling (SPS) is a periodic resource allocation scheme for downlink (DL). Current SPS periodicity values support only integer multiples of 1 ms (i.e., SPS periodicity=ms when the periodicityExt-r17 is configured to 1.) and could not be adopted for XR/CG video streams with 30, 60, 90, or 120 fps. To support non-integer periodicities, the values of 100/3 ins, 50/3 ins, 100/9 ins, and 25/3 ms for 30, 60, 90, and 120 fps respectively should be added for the Rel-18 extensions to the SPS periodicity configuration, as listed in Table 5 below.

TABLE 5
extensions to SPS configuration with non-integer periodicities.

| | |
|---|---|
| SPS-Config ::= | SEQUENCE { |
| periodicityExt-r18 | ENUMERATED {ms100/3, ms50/3, ms100/9, ms25/3, ms64, |

spare4, spare3, spare2, spare1},
...
}

The same values could be configured for the Rel-18 extensions to the Configured Grant (CG) periodicity configuration, as listed in Table 2 below.

TABLE 6
extensions to Configuration Grant (CG) configuration with non-integer periodicities.

| | |
|---|---|
| ConfiguredGrantConfig ::= | SEQUENCE { |

...

| | |
|---|---|
| periodicityExt-r18 | ENUMERATED {ms100/3, ms50/3, ms100/9, ms25/3, ms64, |

spare4, spare3, spare2, spare1},
...

### 2. Modified the XR/CG Cycle Based on the Triggering Equation.

To enable a wireless communication device to access services (such as Extended Reality (XR)/Cloud Gaming (CG) service) provided by a Radio Access Network, an XR/CG configuration is configured, and an XR/CG cycle is configured in the XR/CG configuration, and wherein the XR/CG cycle is modified based on burst arrival interval to eliminate a mismatch between the burst arrival interval and the XR/CG cycle. The XR/CG cycle may be modified in periodicity by a triggering equation. The XR/CG cycle may be modified according to a cumulative difference between the burst arrival interval and the configured XR/CG cycle. The cumulative difference may be normalized by a predefined time interval. The XR/CG cycle may be configured with a nearest integer to the burst arrival interval. In an embodiment, the XR/CG configuration may be a discontinuous reception (DRX) configuration or comprises the DRX configuration, and the XR/CG cycle corresponds to a DRX cycle configured in the DRX configuration. In another embodiment, the XR/CG configuration is a semi-persistent scheduling (SPS) configuration or comprises the SPS configuration, and the XR/CG cycle corresponds to an SPS periodicity configured in the SPS configuration. In still another embodiment, the XR/CG configuration is a configured grant configuration or comprises the configured grant configuration, and the XR/CG cycle corresponds to a configured grant periodicity configured in the configured grant configuration. Multiple XR/CG configurations having a same cycle but with different start offsets may compose one XR/CG configuration that eliminates the mismatch between the burst arrival interval and the XR/CG cycle. Further details are provided below.

This method does not directly configure an XR/CG cycle with non-integer periodicities but modifies the XR/CG cycle in some periodicities by the triggering equation. The advantage of this method is that legacy DRX parameters (e.g., DRX cycle, start offset, slot offset, etc.) could be reused for XR/CG configuration, and non-integer periodicities of the XR/CG cycle could be achieved by adjusting the remainder of the mod function in the triggering equation. The UE may use the new triggering equation when an enabler for XR/CG service is configured (e.g., XRCG-support-r18). Parameters (e.g., on) of the triggering equation may be configured by the Radio Resource Control (RRC) messages.

Take 60 fps as an example, and the burst arrival interval is 16.67 ms. FIG. 7 shows that the XR/CG cycle needs to be modified every 50 ms to eliminate the mismatch between the burst arrival interval and the XR/CG cycle. In order to modify the XR/CG cycle, a remainder, δₙ, is added to the XRCG-StartOffset in the triggering equation: [(SFN×10)+subframe number]mod (XRCG-Cycle)=(XRCG-StartOffset+δₙ) mod (XRCG-Cycle), where δₙ=[n (burst arrival interval−XRCG-Cycle)] and XRCG-Cycle=16 ms.

If the XR/CG cycle is configured as 16 ms, and the XRCG-StartOffset is configured as 6 (i.e., XRCG-Cycle and XRCG-StartOffset could be configured by the gNB), FIG. 8 shows the first subframe number of the ON period of the XR/CG cycle. The XR/CG cycle is modified by the triggering equation to 16 ms, 17 ms, and 17 ms.

The triggering equation may be modified to adjust the XR/CG cycle when the difference between the burst arrival interval and the XR/CG cycle exceeds Tims.

$${δ}_{n} = ⌊ \frac{n \cdot ( burst arrival interval - XRCG - Cycle )}{T} ⌋ \cdot T and XRCG - Cycle = 16 ms .$$

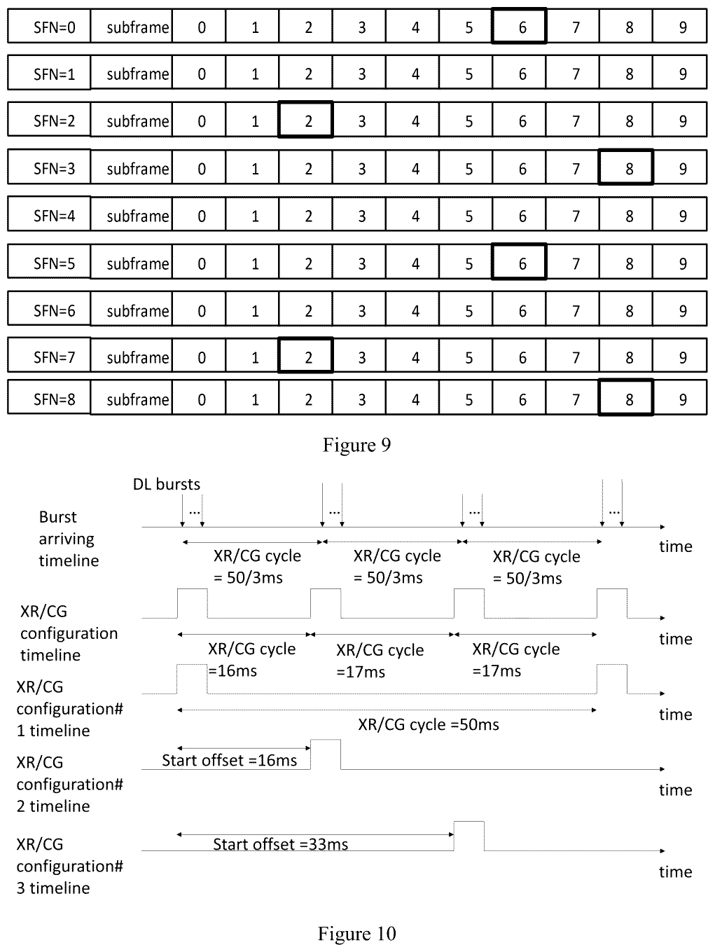

The XR/CG cycle in FIG. 9 shows another example where the XR/CG cycle is modified by the triggering equation to 16 ms, 16 ms, and 18 ms.

### 2.1 Modified the SPS/CG Cycle Based on the Triggering Equation.

Semi-persistent scheduling (SPS) is a periodic resource allocation scheme for downlink (DL). Current SPS periodicity values support only integer multiples of 1 ms (i.e., SPS periodicity=1 ms when the periodicityExt-r17 is configured to 1.), and the SPS periodicities are listed in the following Table 7.

TABLE 7
SPS periodicities (prior art).

| | |
|---|---|
| SPS-Config ::= | SEQUENCE { |
| Periodicity | ENUMERATED {ms10, ms20, ms32, ms40, ms64, |

ms80, ms128, ms160, ms320, ms640, spare6, spare5, spare4, spare3, spare2, spare1},

| | | |
|---|---|---|
| periodicityExt-r17 | INTEGER (1..40960) | OPTIONAL, -- Need R |

...
}

### Table 7—SPS.

To support an SPS configuration with non-integer periodicities, the triggering equation for the N^{th} SPS DL assignment could be modified as: (numberOfSlotsPerFrame×SFN+slot number in the frame)=[(numberOfSlotsPerFrame×SFN_{start time}+slot_{start time})+N×periodicity×numberOfSlotsPerFrame/10+S_{SPS}×numberOfSlotsPerFrame]modulo (1024×numberOfSlotsPerFrame), where numberOfSlotsPerFrame refers to the number of consecutive slots per frame; modulo is a modulo operator; and δ_{SPS}=[N·(burst arrival interval−periodicity)]modulo periodicity, and N≥0.

The periodicity could be configured as the nearest integer to the burst arrival interval. With the modified triggering equation, the SPS cycle could accommodate the DL XR/CG traffic with non-integer periodicities.

In case of non-integer periodicities configured for the SPS configuration, the triggering equation for the N^{th} SPS DL assignment could be modified as: (numberOfSlotsPerFrame×SFN+slot number in the frame)=floor {[(numberOfSlotsPerFrame×SFN_{start time}+slot_{start time})+N×periodicity×numberOfSlotsPerFrame/10]modulo (1024×numberOfSlotsPerFrame)}, where SFN_{start time} and slot_{start time} are the SFN and slot, respectively, of the first transmission of SPS resource where the configured downlink assignment was (re-)initialized. The periodicity comprises non-integer values, such as 100/3 ms, 100/6 ms, 100/9 ms, and 100/12 ms for XR/CG cycles with 30, 60, 90, and 120 fps, respectively.

Since SFN ranges from 0 to 1023, the term (numberOfSlotsPerFrame×SFN+slot number in the frame) ranges from 0 to (1024×numberOfSlotsPerFrame−1) slots that returns to 0 to repeat again when it reaches (1024×numberOfSlotsPerFrame−1). Therefore, if the SPS cycle length is not a factor of (1024×numberOfSlotsPerFrame) slots, each time the SFN value wraps around, the equation will incorrectly calculate the start of the SPS cycle and then propagate this offset to the next cycle. To solve the mismatch at SFN wrap-around, a counter C for the number of wrap-around is added to the above equation as: (1024×numberOfSlotsPerFrame×C+numberOfSlotsPerFrame×SFN+slot number in the frame)=floor {[(numberOfSlotsPerFrame×SFN_{start time}+slot_{start time})+N×periodicity×numberOfSlotsPerFrame/10]modulo (1024×numberOfSlotsPerFrame)}, where the counter C is configured by the gNB to make sure the (1024×numberOfSlotsPerFrame×C+numberOfSlotsPerFrame×SFN+slot number in the frame) can be exactly divided by the XR periodicity.

The above modulo operation could be calculated by the following equation for any two real numbers x, y with y≠0: x mod y=x·y[x/y].

Configured grant (CG) is a periodic resource allocation scheme for uplink (UL). The current supported CG periodicities are listed in the following Table 8. A CG configuration supports the symbol level periodicities, and the minimal periodicity is 2 symbols.

TABLE 8
Configured grant (CG) periodicities (prior art).

| | |
|---|---|
| ConfiguredGrantConfig ::= | SEQUENCE { |

...

| | |
|---|---|
| Periodicity | ENUMERATED { sym2, sym7, sym1x14, |

sym2x14, sym4x14, sym5x14, sym8x14, sym10x14, sym16x14, sym20x14, sym32x14,
sym40x14, sym64x14, sym80x14, sym128x14, sym160x14, sym256x14, sym320x14,
sym512x14, sym640x14, sym1024x14, sym1280x14, sym2560x14, sym5120x14, sym6,
sym1x12, sym2x12, sym4x12, sym5x12, sym8x12, sym10x12, sym16x12, sym20x12,
sym32x12, sym40x12, sym64x12, sym80x12, sym128x12, sym160x12, sym256x12,
sym320x12, sym512x12, sym640x12, sym1280x12, sym2560x12 },
...
}

In order to support a CG configuration with non-integer periodicities, the triggering equation for the N^{th} CG Type 1 and Type 2 assignments could be modified as: UL configured grant Type 1: [(SFN×numberOfSlotsPerFrame×numberOfSymbolsPerSlot)+(slot number in the frame×numberOfSymbolsPerSlot)+symbol number in the slot](timeReferenceSFN×numberOfSlotsPerFrame×numberOfSymbolsPerSlot+timeDomainOffset×numberOfSymbolsPerSlot+S+N×periodicity+δ_{CG}×numberOfSlotsPerFrame×numberOfSymbolsPerSlot) modulo (1024×numberOfSlotsPerFrame×numberOfSymbolsPerSlot).

### UL Configured Grant Type 2:

[(SFN×numberOfSlotsPerFrame×numberOfSymbolsPerSlot)+(slot number in the frame×numberOfSymbolsPerSlot)+symbol number in the slot]=[(SFN_{start time}×numberOfSlotsPerFrame×numberOfSymbolsPerSlot+slot_{start time}×numberOfSymbolsPerSlot+symbol_{start time})+N×periodicity+δ_{CG}×numberOfSlotsPerFrame×numberOfSymbolsPerSlot]modulo (1024×numberOfSlotsPerFrame×numberOfSymbolsPerSlot), where numberOfSymbolsPerSlot refers to the number of consecutive symbols per slot; numberOfSlotsPerFrame refers to the number of consecutive slots per frame; modulo is a modulo operator; and δ_{CG}=[N·(burst arrival interval−periodicity)]modulo periodicity, and N≥0.

The periodicity could be configured as the nearest integer to the burst arrival interval. With the modified triggering equation, the CG cycle could accommodate the UL XR/CG traffic with non-integer periodicities.

In case of non-integer periodicities configured for the configured grant (CG) configuration, the triggering equation for the N^{th} CG Type 1 and Type 2 assignments could be modified as: UL configured grant Type 1: [(SFN×numberOfSlotsPerFrame×numberOfSymbolsPerSlot)+(slot number in the frame×numberOfSymbolsPerSlot)+symbol number in the slot]=floor[(timeReferenceSFN×numberOfSlotsPerFrame×numberOfSymbolsPerSlot+timeDomainOffset×numberOfSymbolsPerSlot+S+N×periodicity) modulo (1024×numberOfSlotsPerFrame×numberOfSymbolsPerSlot)].

UL configured grant Type 2: [(SFN×numberOfSlotsPerFrame×numberOfSymbolsPerSlot)+(slot number in the frame×numberOfSymbolsPerSlot)+symbol number in the slot]=floor{[(SFN_{start time}×numberOfSlotsPerFrame×numberOfSymbolsPerSlot+slot_{start time}×numberOfSymbolsPerSlot+symbol_{start time})+N×periodicity]modulo (1024×numberOfSlotsPerFrame×numberOfSymbolsPerSlot)}, where SFN_{start time}, slot_{start time}, symbol_{start time} are the SFN, slot, and symbol, respectively, of the first transmission opportunity of configured grant where the configured uplink grant was (re-)initialized. The periodicity comprises non-integer values, such as 100/3 ms, 100/6 ms, 100/9 ms, and 100/12 ms for XR/CG cycles with 30, 60, 90, and 120 fps, respectively.

Since SFN ranges from 0 to 1023, the term [(SFN×numberOfSlotsPerFrame×numberOfSymbolsPerSlot)+(slot number in the frame×numberOfSymbolsPerSlot)+symbol number in the slot]ranges from 0 to (1024×numberOfSlotsPerFrame×numberOfSymbolsPerSlot−1) symbols that returns to 0 to repeat again when it reaches (1024×numberOfSlotsPerFrame×numberOfSymbolsPerSlot−1). Therefore, if the configured grant cycle length is not a factor of (1024×numberOfSlotsPerFrame×numberOfSymbolsPerSlot) symbols, each time the SFN value wraps around, the equation will incorrectly calculate the start of the configured grant cycle and then propagate this offset to the next cycle. To solve the mismatch at SFN wrap-around, a counter D for the number of wrap-around is added to the triggering equation as:

UL configured grant Type 1: [1024×numberOfSlotsPerFrame×numberOfSymbolsPerSlot×D+(SFN×numberOfSlotsPerFrame×numberOfSymbolsPerSlot)+(slot number in the frame×numberOfSymbolsPerSlot)+symbol number in the slot]=floor[(timeReferenceSFN×numberOfSlotsPerFrame×numberOfSymbolsPerSlot+timeDomainOffset×numberOfSymbolsPerSlot+S+N×periodicity) modulo (1024×numberOfSlotsPerFrame×numberOfSymbolsPerSlot)].

UL configured grant Type 2: [1024×numberOfSlotsPerFrame×numberOfSymbolsPerSlot×D+(SFN×numberOfSlotsPerFrame×numberOfSymbolsPerSlot)+(slot number in the frame×numberOfSymbolsPerSlot)+symbol number in the slot]=floor{[(SFN_{start time}×numberOfSlotsPerFrame×numberOfSymbolsPerSlot+slot_{start time}×numberOfSymbolsPerSlot+symbol_{start time})+N×periodicity]modulo (1024×numberOfSlotsPerFrame×numberOfSymbolsPerSlot)}, where the counter D is configured by the gNB to make sure the [1024×numberOfSlotsPerFrame×numberOfSymbolsPerSlot×D+(SFN×numberOfSlotsPerFrame×numberOfSymbolsPerSlot)+(slot number in the frame×numberOfSymbolsPerSlot)+symbol number in the slot] can be exactly divided by the XR periodicity.

By the way, the above modulo operation could be calculated by the following equation for any two real numbers x, y with y≠0: x mod y=x−y·[x/y].

### 3. Modified the XR/CG Cycle by Configuring Multiple XR/CG Configurations.

To enable a wireless communication device to access services (such as Extended Reality (XR)/Cloud Gaming (CG) service) provided by a Radio Access Network, multiple discontinuous reception (DRX) configurations with different start offsets and different DRX cycles are configured, and one of the multiple DRX configurations is activated at a time. A current DRX configuration may be deactivated and another DRX configuration may be activated. For uplink (UL) bursts, an indication may be used to notify an end of the UL bursts. The indication may comprise a buffer status report (BSR) or a DRX switch Medium Access Control (MAC) control element (CE). Each of the multiple DRX configurations may have its own parameters, and the parameters may comprise at least one of ON period interval, ON period extension, long DRX cycle, short DRX cycle, and start offset. Further details are provided below.

According to FIG. 7, the XR/CG configuration with {16 ms, 17 ms, 17 ms} cycles may also be composed of multiple XR/CG configurations. Considering the use case of 60 fps, it means that there are 3 video frames arriving every 50 ms. One XR/CG configuration could be configured for each video frame, and three XR/CG configurations having the same cycles (i.e., 50 ms) but with different start offsets (i.e., 0 ms, 16 ms, 33 ms) could accommodate the video stream. FIG. 10 illustrates how the three XR/CG configurations compose one XR/CG configuration. The advantage of this method is that there is no need to configure non-integer periodicities. However, multiple XR/CG configurations may incur more signaling overhead.

### 4. Handling Jitter of Traffic Arrival Time.

To enable a wireless communication device to access services (such as Extended Reality (XR)/Cloud Gaming (CG) service) provided by a Radio Access Network, a specific cycle is configured with an ON period for transmission of at least one of control information or data and an OFF period during which the transmission is suspended, and wherein the ON period of the specific cycle is extended to cover an arrival interval of at least one data burst plus a data arrival jitter. The specific cycle may be an Extended Reality (XR)/Cloud Gaming (CG) cycle configured in an XR/CG configuration. The ON period may transition to the OFF period in response to a go-to-sleep indication on the ON period. In response to a data packet transmission during the ON period, a timer may be activated or re-activated, and the extended ON period may be further extended till the time when the timer is expired. The specific cycle with the extended ON period may comprise a long cycle and associated short cycles. The specific cycle may have at least two levels comprising an outer level corresponding to the long cycle and an inner level corresponding to the associated short cycles. The transmission of the at least one of control information or data may be only carried out during ON periods of the associated short cycles. In response to a go-to-sleep indication on ON period of one of the associated short cycles, subsequent short cycles may be turned off. A first timer of the long cycle may be used to extend ON period of the long cycle, and a second timer of the short cycle is used to extend ON period of the short cycle. The long cycle may be an XR/CG cycle configured in an XR/CG configuration, and the short cycle is a discontinuous reception (DRX) cycle configured in a DRX configuration. The XR/CG cycle may be a long DRX cycle. The long cycle may be a DRX cycle configured in a DRX configuration, and the short cycle may be an XR/CG cycle configured in an XR/CG configuration. Multiple XR/CG configurations may be configured to support multi-modality services. The ON period of the specific cycle may be configured in a semi-persistent scheduling (SPS) configuration, and the specific cycle may correspond to an SPS periodicity comprising at least one of 100/3, 50/3, 100/9 or 25/3 in a unit of microsecond. The ON period of the specific cycle may be configured in a configured grant configuration, and the specific cycle may correspond to a configured grant periodicity comprising at least one of 100/3, 50/3, 100/9 or 25/3 in a unit of microsecond. Further details are provided below.

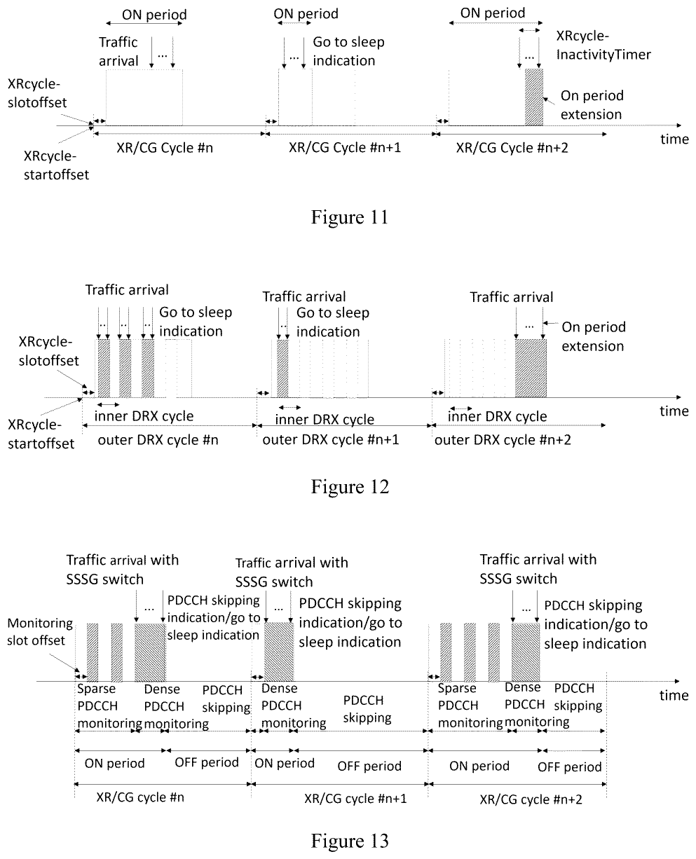

The XR/CG's traffic arrival time is not deterministic but jittered by a value. Based on the study of 3GPP Technical Report (TR) 38.838, the jitter follows truncated Gaussian distribution with ranges of [−4 ms, 4 ms] or [−5 ms, 5 ms]. It means that the XR/CG's traffic arrives within a range of 8/10 ms with a possibility (e.g., 90 or 95 percentile). In order to overcome the impact of jitter, the most straightforward way is to extend the ON period to accommodate most of the XR/CG traffic arrival. (e.g., 90 or 95 percentile of the truncated Gaussian distribution) As shown in FIG. 11, the ON period is configured to (i.e., by appropriately configuring XRcycle-startoffset and XRcycle-onDurationTimer) at least 8/10 ms long to resolve the jitter problem. During the ON period, the UE needs to continuously monitor the PDCCH to check the traffic arrival such that the UE power consumption is increased as the ON period is extended. To reduce the power consumption, the ‘go to sleep’ indication (e.g., DRX Command MAC CE, Long DRX Command MAC CE, or DCI based PDCCH skipping indication) could be indicated by the gNB to request the UE to enter OFF period when the transmission is finished early in the ON period. In case the XR/CG traffic arrives late during the ON period, the XRcycle-InactivityTimer may be used to extend the ON period to finish the burst transmission. The XRcycle-InactivityTimer is activated/re-activated when receiving a packet (or DCI) during the ON period, and the UE enters OFF period when the XRcycle-InactivityTimer is expired.

It may be not efficient to continuously monitor the unpredictable traffic arrival within the ON period. A more efficient way is to configure inner short cycles within the ON period of another outer long cycle. (e.g., an XR/CG cycle) The XR/CG cycle may be a long DRX cycle and most of the existing DRX parameters (e.g., drx-onDurationTimer, drx-onDurationTimer, drx-LongCycleStartOffset, drx-SlotOffset, etc.) can be reused. The ON period of the (outer) XR/CG cycle could be configured to be a value long enough to resolve the XR/CG arrival jitter. The inner periodical cycles may reuse the existing DRX mechanism. The (outer) XR/CG cycle may be configured when a UE supports XR/CG data transmission. (e.g., an enabler of XRCG-support-r18 is configured) The (outer) XR/CG cycle may be activated when a downlink information transmission (e.g., RRC message, MAC CE, DCI, etc.) is received by the UE. The start point of the outer XR/CG cycle can be controlled by XRcycle-slotoffset and XRcycle-startoffset and may not align with the start point of the inner DRX cycle. The outer XR/CG and the inner DRX configurations are two-level DRX configurations where the outer level is configured to resolve the traffic arrival jitter and the inner level is configured to accommodate the traffic burst arrival and reduce the power consumption of PDCCH monitoring. The UE only needs to wake up in the relatively short ON period of the inner DRX cycles to monitor the PDCCH. For example, when the XR/CG traffic pattern is 60 fps with a jitter of [−4 ms, 4 ms], the ON period of the outer XR/CG cycle in FIG. 12 can be configured as 8 ms, the periodicity of the outer XR/CG cycle is configured as 16.67 ms, and the inner DRX cycle is configured as 2 ms (i.e., the ON period of the inner DRX cycle is 1 ms). The number of the short DRX cycle can be configured as 4 (i.e., drx-ShortCycleTimer=4) to cover the jitter of one traffic burst. In such a configuration, when the XR/CG traffic arrives during the OFF period of the inner DRX cycle, the maximum waiting time for transmission is 1 ms. To further reduce the power consumption, the ‘go to sleep’ indication (e.g., DRX Command MAC CE, Long DRX Command MAC CE, or DCI based PDCCH skipping indication) could be used to request the UE to enter the OFF period and turn off the subsequent short DRX cycle(s) after completing the transmission during the ON period. In case the XR/CG traffic requires more radio resource for transmission, the ON period of the outer XR/CG cycle and the inner DRX cycle may be extended to finish the data transmission. An XR/CG inactivity timer could be used to extend the ON period of the outer XR/CG cycle and the drx-InactivityTimer could be reused to extend the ON period of the inner DRX cycle.

Note that the XR/CG cycle may be configured as inner short cycle and the outer long cycles may reuse the legacy DRX mechanism. The same configurations for the above example could be reused, in which the ON period outer DRX cycle is configured as 8 ms, the periodicity of the outer DRX cycle is configured as 16.67 ms, and the inner XR/CG cycle is configured as 2 ms. In this case, the DRX cycle of non-integer periodicity is not supported in current 3GPP release and should be enhanced in the future 3GPP releases. The advantage of this case is that multiple inner XR/CG configurations within the ON period of the outer DRX configuration may be configured to support multi-modality services. How to configure multiple XR/CG configurations will be described in the following subsection.

Note that the UE monitors the PDCCH only when the outer cycle and the inner cycle are during ON state. When one of the outer cycles and the inner cycle is during OFF state, the UE does not monitor the PDCCH to reduce power consumption.

To enable a wireless communication device to access services (such as Extended Reality (XR)/Cloud Gaming (CG) service) provided by a Radio Access Network, physical downlink control channel (PDCCH) monitoring periodicity is dynamically changed based on a search space set group (SSSG) switch indication, and at least two search spaces are configured, one of the at least two search spaces is for sparse PDCCH monitoring and the other one of the at least two search spaces is for dense PDCCH monitoring. PDCCH monitoring may be carried out with a first monitoring periodicity during the sparse PDCCH monitoring and with a second monitoring periodicity during the dense PDCCH monitoring, and first monitoring periodicity may be larger than the second monitoring periodicity. The sparse PDCCH monitoring may be configured in response to no traffic arrival, and the dense PDCCH monitoring may be configured in response to traffic arrival. In response to the SSSG switch indication, the sparse PDCCH monitoring may be changed to the dense PDCCH monitoring or the dense PDCCH monitoring may be changed to the sparse PDCCH monitoring. In response to a PDCCH skipping indication via a Layer 1 signaling or a go-to-sleep indication via a higher layer signaling, subsequent PDCCH monitoring may be skipped. A timer may be configured during the dense PDCCH monitoring, and the dense PDCCH monitoring may be switched to the sparse PDCCH monitoring when the timer is expired. The SSSG switch indication is to configure the dense PDCCH monitoring in response to traffic arrival, and the SSSG switch indication is to configure the sparse PDCCH monitoring in response to finished traffic transmission. The PDCCH monitoring periodicity may be dynamically changed during a discontinuous reception (DRX) ON period. The DRX ON period may be ended by a PDCCH skipping indication via a Layer 1 signaling or a go-to-sleep indication via a higher layer signaling. The PDCCH monitoring periodicity may be dynamically changed among semi-persistent scheduling (SPS) resources. The SPS resource may be ended by a PDCCH skipping indication via a Layer 1 signaling or a go-to-sleep indication via a higher layer signaling. Further details are provided below.

FIG. 13 shows an alternative way to periodically monitor PDCCH based on search space set group (SSSG) switching. During the ON period of XR/CG cycle, the gNB could dynamically adjust the PDCCH monitoring periodicity for the UE based on an SSSG switch indication. The gNB may configure the UE with two (or more than two) search spaces, one of which is for sparse PDCCH monitoring and the other one of which is for dense PDCCH monitoring. Within the sparse PDCCH monitoring duration, the UE monitors the PDCCH less frequently with large slot periodicity (e.g., 2 or 4 slots). When the ON period of the XR/CG cycle starts, sparse PDCCH monitoring may be configured for the UE. It is most likely no traffic arrives at the beginning of the ON period, especially when long period is configured to resolve the traffic arrival jitter. The sparce PDCCH monitoring is like a DRX configuration with large periodicity. The difference is that SSSG switching is controlled by a PHY layer indication (e.g., DCI), but DRX cycle switching is controlled by an RRC message. SSSG switching could react to the traffic arrival faster than DRX cycle switching and the gNB could dynamically adjust the PDCCH monitoring periodicity to reduce UE power consumption. When the traffic arrives, the gNB indicates SSSG switching to adjust the PDCCH monitoring with small monitoring slot periodicity (e.g., 1 slot) and the UE could receive the traffic in the associated Physical Downlink Share Channel (PDSCH) as soon as possible. After completing the traffic burst transmission during the ON period, the gNB may transmit a PDCCH skipping indication or a go-to-sleep indication to the UE to skip the subsequent PDCCH monitoring. An alternative way is to let the UE continuously monitor the PDCCH until end of the ON period. After the OFF period, the gNB may indicate SSSG switching to the UE again to trigger the UE with sparse PDCCH monitoring. A timer may be configured together with the PDCCH skipping indication. If the timer is configured (e.g., the length of the timer may be configured equal to the OFF period), the UE could autonomously switch back to sparse PDCCH monitoring when the timer is expired.

### 5. Supporting Multi-Modality Services for XR/CG.

To enable a wireless communication device to access multi-modality services provided by a Radio Access Network, wherein an Extended Reality (XR)/Cloud Gaming (CG) configuration is configured for the multi-modality services, and an XR/CG cycle is configured in the XR/CG configuration, and wherein multiple periodic resources are scheduled in an ON period of the XR/CG cycle configured in the XR/CG configuration. The multiple periodic resources scheduled in the XR/CG cycle at least may comprise multiple uplink (UL) configured grants. The multiple periodic resources scheduled in the XR/CG cycle at least may comprise multiple downlink (DL) semi-persistent schedulings (SPSs). The XR/CG cycle may be configured as a common multiple of periodicities of DL streams and UL streams. The ON period of the XR/CG cycle may be configured to cover DL burst arrival jitter. The ON period of the XR/CG cycle may be configured for one or more semi-persistent scheduling (SPS) resources. The ON period of the XR/CG cycle may be configured for one or more configured grant resources. A UL burst of a UL stream may be transmitted on an uplink resource configured in the XR/CG configuration for a subsequent UL burst of the UL stream. A first UL burst of a UL stream may be transmitted on a first uplink resource configured in the XR/CG configuration, and a second UL burst of the UL stream may be transmitted on a second uplink resource configured in another XR/CG configuration. Further details are provided below.

For the XR/CG applications, tactile and multi-modal data (e.g., audio, video, and haptic data) may be delivered to the UE for XR/CG service. Therefore, each XR/CG traffic may comprise multiple streams and each stream may have its burst arrival periodicity with a corresponding burst arrival time. If the burst arrival jitter is not significant, periodic resource allocation, such as downlink semi-persistent scheduling (SPS) or uplink configured grant (CG), may be used for multi-modality services. SPS and CG could reduce the signalling for periodic resource allocation.

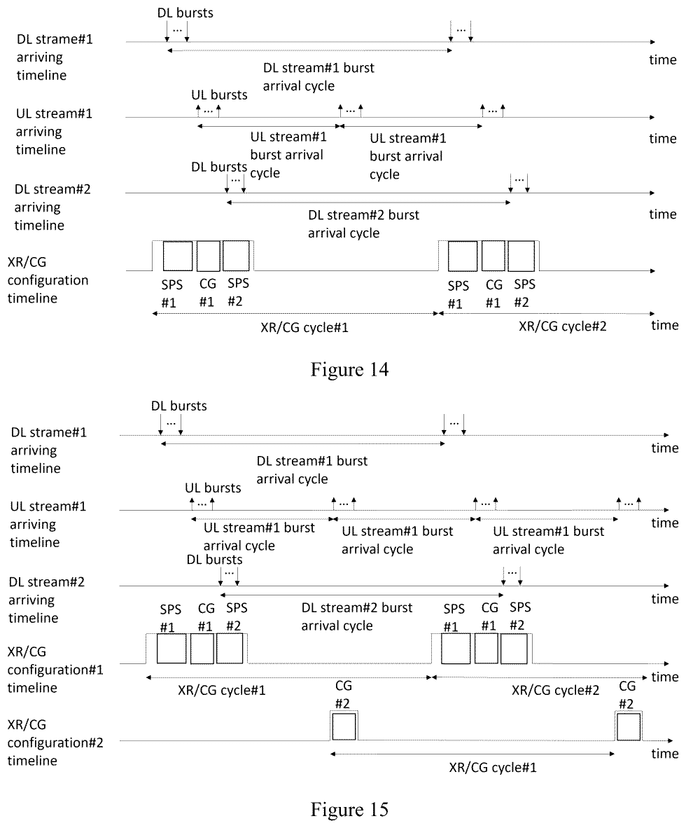

As shown in FIG. 14, one XR/CG cycle comprise two DL streams and one UL stream. Within the ON period of the XR/CG cycle, each DL stream is configured with an SPS configuration (i.e., SPS #1 configuration for DL stream #1 and SPS #2 configuration for DL stream #2), and the bursts of the DL stream could be transmitted on the associated SPS resource. Each UL stream is configured with a CG configuration. (i.e., CG #1 configuration for UL stream #1), and the bursts of the UL stream could be transmitted on the associated CG resource. Within one XR/CG cycle, the SPS #1, CG #1, and SPS #2 configurations can be grouped as a configuration for an XR/CG service. With multiple SPS/CG configurations the capacity of an XR/CG service could be increased.

The XR/CG cycle may be configured as a common multiple of the periodicities of the DL streams and the UL stream, and the ON period may be configured for a longer interval to cover the DL burst arrival jitter. If the periodicities of DL/UL stream are non-integer, the methods in section 1 and 2 could be adopted to configure the XR/CG cycle length. For the example in FIG. 14, no immediate uplink resource is configured for the second bursts of the UL stream #1 if quality of service (QoS) is not violated. The second bursts of the UL streamt #1 may be transmitted together with the third bursts on the second uplink resource of CG #1 configuration.

In FIG. 15, immediate uplink resource is configured in another XR/CG configuration for the second bursts of the UL stream #1. In this case, multiple XR/CG configurations are configured for an XR/CG service. The power consumption may be increased because the UE wakes up more frequently to transmit/receive the data burst, but at the same time the bursts could be transmitted as early as possible without causing QoS violation.

### 6. The Procedures of Configuring DRX Configuration(s) for a UE.

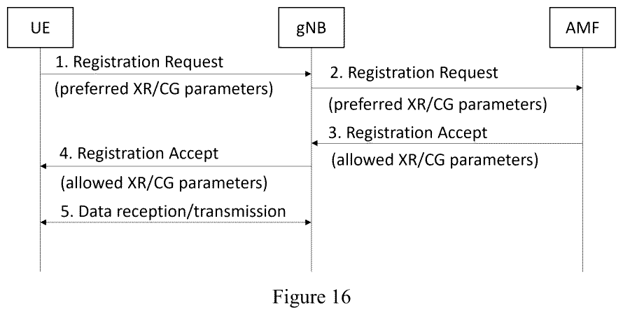

FIG. 16 shows the procedure of XR/CG resource allocation for a UE.
Step 1: When the UE registers to the network, it transmits a Registration Request message to the gNB. The Registration Request message may include the US Assistance Information carrying UE preferred XR/CG parameters. The UE preferred XR/CG parameters may include the preferredXRCG-Cycle, the preferredXRCG-InactivityTimer, XRCGcycle-slotoffset, and/or XRCGcycle-startoffset.
Note 1: The preferredXRCG-Cycle may include the non-integer periodicities (e.g., 100/3 ms, 50/3 ms, 100/9 ms, 25/3 ms, etc.) for XR/CG traffic.
Note 2: The UE Assistance Information is optional. Without this information, the AMF could also determine the XR/CG parameters based on the traffic information received from the XR/CG application server.
Note 3: The UE Assistance Information may include a capability of supporting XR/CG service by the UE. (e.g., XRCG-Assistance-r18).
Step 2: The gNB forwards the Registration Request message with the UE preferred XR/CG parameters to the Access and Mobility Management Function (AMF).
Step 3: The AMF determines if the preferred XR/CG parameters could be allowed. The AMF replies a Registration Accept message with allowed XR/CG parameters.
Note 1: The AMF may be informed with traffic information from the XR/CG application server. The traffic information may include media codec, traffic burst size, traffic periodicity, traffic rate, traffic jitter (e.g., jitter distribution includes mean and standard deviation), number of (continuous) packets, etc. The AMF uses the information to determine the allowed XR/CG parameters.
Step 4: The gNB forwards the Registration Accept message to the UE. The allowed XR/CG parameters may be configured by the RRC messages (e.g., RRCReconfiguration, RRCResume, or RRCSetup message).
Note 1: The gNB may transmit an enabler (e.g., XRCG-support-r18) to the UE to enable the XR/CG configuration.
Note 2: As described in sections 3 and 5, the gNB may configure more than one XR/CG configuration for the UE.
Note 3: In the RRC messages (e.g., RRCReconfiguration, RRCResume, or RRCSetup message), a group of SPS/CG configurations for an XR/CG may be configured for the UE. The group of SPS/CG configurations may be associated with an XR/CG service/configuration. The grouped SPS/CG configurations may be configured by an identity. (e.g., a group identity or an XR/CG identity) The identity may be used for activating/de-activating the (pre)configured SPS/CG configurations. When a packet belonging to an SPS/CG configuration fails, the subsequent packet(s) belonging to the other SPS/CG configuration(s) in the same group may be useless. The gNB may use the identity to de-activate the SPS/CG configurations of the UE, and the de-activated radio resource could be used for scheduling other UE(s).
Note 4: For the non-integer periodicity of XR/CG traffic burst interval, a periodicity extension with non-integer periodicities for SPS configuration (e.g., SPSperiodicityExt-r18) may be configured in the SPS configuration message. (e.g., SPS-Config IE). If the SPS cycle modification based on the triggering equation is adopted, the parameters (e.g., numberOfSlotsPerFrame, periodicity, counter C, and XRCG-Cycle) should be together configured by the gNB.
Note 5: For the non-integer periodicity of XR/CG traffic burst interval, a periodicity extension with non-integer periodicities for Configured Grant (CG) configuration (e.g., CGperiodicityExt-r18) may be configured in the CG configuration message. (e.g., ConfiguredGrantConfig IE) If the CG cycle modification based on the triggering equation is adopted, the parameters (e.g., numberOfSlotsPerFrame, numberOfSymbolsPerSlot, timeReferenceSFN, timeDomainOffset, periodicity, counter D, and XRCG-Cycle) should be together configured by the gNB.
Step 5: The UE is configured with the allowed XR/CG parameters. The UE wakes up at the ON period based on the methods in sections 1-5 and transmits/receives data during the ON period.

Commercial interests for some embodiments are as follows. 1. solving issues in the prior art. 2. Realize XR/CG enhancements. 3. saving power consumption. 4. supporting multi-modality services 5. providing a good communication performance. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product. Some embodiments of the present disclosure could be adopted in the 5G NR unlicensed band communications. Some embodiments of the present disclosure propose technical mechanisms.

The embodiment of the present application further provides a user equipment (UE), including: a memory, configured to store program instructions; a transceiver, configured to transmit and receive data; and a processor, coupled to the memory and the transmitter, configured to call and run the program instructions stored in a memory, to cooperate with the memory to execute corresponding processes in each of the methods of the embodiments of the present disclosure. For brevity, details will not be described herein again.

The embodiment of the present application further provides abase station (BS), including: a memory, configured to store program instructions; a transceiver, configured to transmit and receive data; and a processor, coupled to the memory and the transmitter, configured to call and run the program instructions stored in a memory, to cooperate with the memory to execute corresponding processes in each of the methods of the embodiments of the present disclosure. For brevity, details will not be described herein again.

The embodiment of the present application further provides a computer readable storage medium for storing a computer program. The computer readable storage medium enables a computer to execute corresponding processes implemented by the UE/BS in each of the methods of the embodiments of the present disclosure. For brevity, details will not be described herein again.

The embodiment of the present application further provides a computer program product including computer program instructions. The computer program product enables a computer to execute corresponding processes implemented by the UE/BS in each of the methods of the embodiments of the present disclosure. For brevity, details will not be described herein again.

The embodiment of the present application further provides a computer program. The computer program enables a computer to execute corresponding processes implemented by the UE/BS in each of the methods of the embodiments of the present disclosure. For brevity, details will not be described herein again.

Although not shown in detail any of the devices or apparatus that form part of the network may include at least a processor, a storage unit and a communications interface, wherein the processor unit, storage unit, and communications interface are configured to perform the method of any aspect of the present invention. Further options and choices are described below.

The signal processing functionality of the embodiments of the invention especially the gNB and the UE may be achieved using computing systems or architectures known to those who are skilled in the relevant art. Computing systems such as, a desktop, laptop or notebook computer, hand-held computing device (PDA, cell phone, palmtop, etc.), mainframe, server, client, or any other type of special or general purpose computing device as may be desirable or appropriate for a given application or environment can be used. The computing system can include one or more processors which can be implemented using a general or special-purpose processing engine such as, for example, a microprocessor, microcontroller or other control module.

The computing system can also include a main memory, such as random access memory (RAM) or other dynamic memory, for storing information and instructions to be executed by a processor. Such a main memory also may be used for storing temporary variables or other intermediate information during execution of instructions to be executed by the processor. The computing system may likewise include a read only memory (ROM) or other static storage device for storing static information and instructions for a processor.

The computing system may also include an information storage system which may include, for example, a media drive and a removable storage interface. The media drive may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media may include, for example, a hard disk, floppy disk, magnetic tape, optical disk, CD or DVD, or other fixed or removable medium that is read by and written to by media drive. The storage media may include a computer-readable storage medium having particular computer software or data stored therein.

In alternative embodiments, an information storage system may include other similar components for allowing computer programs or other instructions or data to be loaded into the computing system. Such components may include, for example, a removable storage unit and an interface, such as a program cartridge and cartridge interface, a removable memory (for example, a flash memory or other removable memory module) and memory slot, and other removable storage units and interfaces that allow software and data to be transferred from the removable storage unit to computing system.

The computing system can also include a communications interface. Such a communications interface can be used to allow software and data to be transferred between a computing system and external devices. Examples of communications interfaces can include a modem, a network interface (such as an Ethernet or other NIC card), a communications port (such as for example, a universal serial bus (USB) port), a PCMCIA slot and card, etc. Software and data transferred via a communications interface are in the form of signals which can be electronic, electromagnetic, and optical or other signals capable of being received by a communications interface medium.

In this document, the terms ‘computer program product’, ‘computer-readable medium’ and the like may be used generally to refer to tangible media such as, for example, a memory, storage device, or storage unit. These and other forms of computer-readable media may store one or more instructions for use by the processor including the computer system to cause the processor to perform specified operations. Such instructions, generally referred to as ‘computer program code’ (which may be grouped in the form of computer programs or other groupings), when executed, enable the computing system to perform functions of embodiments of the present invention. Note that the code may directly cause a processor to perform specified operations, be compiled to do so, and/or be combined with other software, hardware, and/or firmware elements (e.g., libraries for performing standard functions) to do so.

The non-transitory computer readable medium may include at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory. In an embodiment where the elements are implemented using software, the software may be stored in a computer-readable medium and loaded into computing system using, for example, removable storage drive. A control module (in this example, software instructions or executable computer program code), when executed by the processor in the computer system, causes a processor to perform the functions of the invention as described herein.

Furthermore, the inventive concept can be applied to any circuit for performing signal processing functionality within a network element. It is further envisaged that, for example, a semiconductor manufacturer may employ the inventive concept in a design of a stand-alone device, such as a microcontroller of a digital signal processor (DSP), or application-specific integrated circuit (ASIC) and/or any other sub-system element.

It will be appreciated that, for clarity purposes, the above description has described embodiments of the invention with reference to a single processing logic. However, the inventive concept may equally be implemented by way of a plurality of different functional units and processors to provide the signal processing functionality. Thus, references to specific functional units are only to be seen as references to suitable means for providing the described functionality, rather than indicative of a strict logical or physical structure or organization.

Aspects of the invention may be implemented in any suitable form including hardware, software, firmware or any combination of these. The invention may optionally be implemented, at least partly, as computer software running on one or more data processors and/or digital signal processors or configurable module components such as field programmable gate array (FPGA) devices.

Thus, the elements and components of an embodiment of the invention may be physically, functionally and logically implemented in any suitable way. Indeed, the functionality may be implemented in a single unit, in a plurality of units or as part of other functional units. Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

While the present application has been described in connection with what is considered the most practical and preferred embodiments, it is understood that the present application is not limited to the disclosed embodiments but is intended to cover various arrangements made without departing from the scope of the broadest interpretation of the appended claims.

1. A method for enabling a wireless communication device to access services provided by a Radio Access Network, wherein an Extended Reality (XR) configuration is configured, and a non-integer periodicity is configured in the XR configuration for XR traffic; and
wherein the XR configuration is a semi-persistent scheduling (SPS) configuration that is a periodic resource allocation scheme for downlink (DL).

2. The method of claim 1, wherein the non-integer periodicity of the SPS configuration comprises at least one of 100/3, 50/3, 100/9, or 25/3 in a unit of microsecond, which is configured in a Radio Resource Control (RRC) information element (IE).

3. The method of claim 1, wherein a triggering equation with floor operation is used for determining SPS assignments.

4. The method of claim 3, wherein a counter for a number of system frame number (SFN) wrap-around is added to the triggering equation.

5. The method of claim 1, wherein the non-integer periodicity based on a burst arrival interval is provided by a user equipment (UE) and/or an application server to a base station for configuring an SPS periodicity.

6. The method of claim 1, wherein a data arrival jitter is provided by a UE and/or a network entity in a 5G core network to a base station for configuring the SPS configuration.

7. A method for enabling a wireless communication device to access services provided by a Radio Access Network, wherein an Extended Reality (XR) configuration is configured, and a non-integer periodicity is configured in the XR configuration for XR traffic; and
wherein the XR configuration is a configured grant configuration that is a periodic resource allocation scheme for uplink (UL).

8. The method of claim 7, wherein the non-integer periodicity comprises at least one of 100/3, 50/3, 100/9, or 25/3 in a unit of microsecond, which is configured in a Radio Resource Control (RRC) information element (IE).

9. The method of claim 8, wherein a triggering equation with floor operation is used for determining configured grant assignments.

10. The method of claim 9, wherein a counter for a number of system frame number (SFN) wrap-around is added to the triggering equation.

11. The method of claim 8, wherein the non-integer periodicity based on a burst arrival interval is provided by a user equipment (UE) and/or an application server to a base station for configuring a configured grant periodicity.

12. The method of claim 8, wherein a data arrival jitter is provided by a UE and/or a network entity in a 5G core network to a base station for configuring the configured grant configuration.

13. A method for enabling a wireless communication device to access services provided by a Radio Access Network, wherein an Extended Reality (XR) configuration is configured, and a non-integer periodicity is configured in the XR configuration for XR traffic;
wherein the XR traffic comprises at least one downlink (DL) data burst and at least one uplink (UL) data burst; and
wherein the XR configuration comprises grouped at least one semi-persistent scheduling (SPS) configuration for the at least one DL data burst and at least one configured grant configuration for the at least one UL data burst.

14. The method of claim 13, wherein the non-integer periodicity comprises at least one of 100/3, 50/3, 100/9, or 25/3 in a unit of microsecond, which is configured in a Radio Resource Control (RRC) information element (IE).

15. The method of claim 13, wherein the non-integer periodicity of the XR configuration is a common multiple of periodicities of the at least one DL data burst and the at least one UL data burst.

16. The method of claim 13, wherein a non-integer periodicity of an UL data provided by a user equipment (UE) and/or a non-integer periodicity of a DL data provided by an application server are transmitted to a base station for configuring the XR configuration.

17. The method of claim 13, wherein a data arrival jitter is provided by a UE and/or a network entity in a 5G core network to a base station for configuring the XR configuration.
